(19) United States
(12) Patent Application Publication
(10) Pub. No.: US 2015/0183120 A1
(43) Pub. Date: Jul. 2, 2015

(54) Utility Knife

(71) Applicant: Ralph Jones, Tallahassee, FL (US)

(72) Inventor: Ralph Jones, Tallahassee, FL (US)

(21) Appl. No.: 14/144,974

(22) Filed: Dec. 31, 2013

(51) Int. Cl. B26B 27/00

(52) U.S. Cl. CPC B26B 27/00

(57) ABSTRACT

The utility knife device generally comprises a blade housing covering a portion of the user's hand, including a casing, a blade and a trigger. The blade housing is made up of a casing which preferably encloses the user's index finger, a blade housed within the casing and a trigger which extends out of the casing and manipulates the blade. The blade is capable of extending outward from the casing being held in place for use. The blade is also capable of automatically retracting within the casing so that the blade is not exposed.

### CROSS-REFERENCES TO RELATED APPLICATIONS

This non-provisional application is a continuation-in-part of U.S. application Ser. No. 13/486,534, The prior application was filed on Jun. 1, 2012. It is listed as the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of devices for utility knives. More specifically, the invention comprises a. retractable utility knife attachable to the hand of a user.

2. Description of the Related Art

Many tasks require use of a razor blade. Stockroom jobs are among many jobs which often require an individual to carry a razor blade or cutting knife on his/her person. A stockroom worker, such as a grocery store stocker, is required to open multiple cardboard boxes throughout the day. In order to open a box, the worker must retrieve the cutting tool from his/her pocket, slice the box and return the tool to his/her pocket or belt. The worker is unable to move quickly from box to box and can leave the cutting tool behind if she/he sets it down. Additionally, the cutting tool is often left exposed and can result in accidental injury to the worker's hand or body.

There are many cutting tools that can be used to open a box. However, no cutting tool is capable of being attached to a user's hand in a safe manner such that the user can expose and retract a blade with the use of one hand. Additionally, the blade is capable of locking in place to simply and efficiently cut the likes of a cardboard box open.

Therefore what is needed is a utility knife which allows simple and efficient slicing of an object, such as a cardboard box. The present invention achieves this objective, as well as others that are explained in the following description.

### BRIEF SUMMARY OF THE INVENTION

The present invention comprises a utility knife device which fits over and is thereby attached to a user's hand. The utility knife device is generally comprised of a sheath, covering a portion of the user's hand and a blade housing which attach together at a connection point. The blade housing is made up of a casing which preferably encloses the user's index finger, a blade housed within the casing and a trigger which extends out of the casing and manipulates the blade. The blade is capable of extending outward from the casing for use and retracting within the casing so that the blade is not left exposed.

### BRIEF DESCRIPTION OF THE SEVERAL VIEWS OF THE DRAWINGS

FIG. 1 is a perspective view, showing the present utility knife device with the blade exposed.

FIG. 2 is a perspective view, showing the present utility knife device with the blade retracted.

FIG. 3 is a perspective view, showing the present utility knife ejecting the blade.

FIG. 4 is a perspective view, showing the present utility knife from above.

FIG. 5 is an exploded view, showing several component parts of the assembly within the blade housing.

FIG. 6 is a cross section view, showing the blade housing.

FIG. 7 is a perspective view with the blade housing and blade itself cut away to show the interaction of lock track and lock pole.

FIG. 8 is a perspective view, showing an alternate embodiment of the present invention.

FIG. 9 is a sectional view, showing an alternate blade housing of the present invention.

FIG. 10 is a perspective view, showing an alternate embodiment of the present invention.

FIG. 11 is a perspective view, showing the blade extension in the alternate embodiment described in FIG. 10.

FIG. 12 is a perspective view, showing the advantage of the embodiment of FIG. 10.

FIG. 13 is a perspective view, showing the application of the embodiment of FIG. 10.

REFERENCE NUMERALS IN THE DRAWINGS

| | | | |
|---|---|---|---|
| 10 | utility knife device | 12 | sheath |
| 14 | protective cover | 16 | tip cover |
| 18 | blade housing | 20 | casing |
| 22 | trigger | 24 | lock track |
| 26 | blade | 28 | wrist portion |
| 30 | soft cover | 32 | connection point |
| 34 | strap | 36 | knuckle portion |
| 38 | lock pole | 40 | pole spring |
| 42 | blade tray | 44 | groove |
| 46 | tray floor | 48 | strap opening |
| 50 | alternate embodiment | 52 | series of straps |
| 54 | alternate blade housing | 56 | channels |
| 58 | positioning slope | 60 | spring |
| 62 | slide channel | 64 | user's first digit |
| 66 | secondary knuckle | 68 | strap |
| 70 | blade opening | 71 | adjustment knob |
| 72 | user's second digit | 74 | cardboard box |

### DETAILED DESCRIPTION OF THE INVENTION

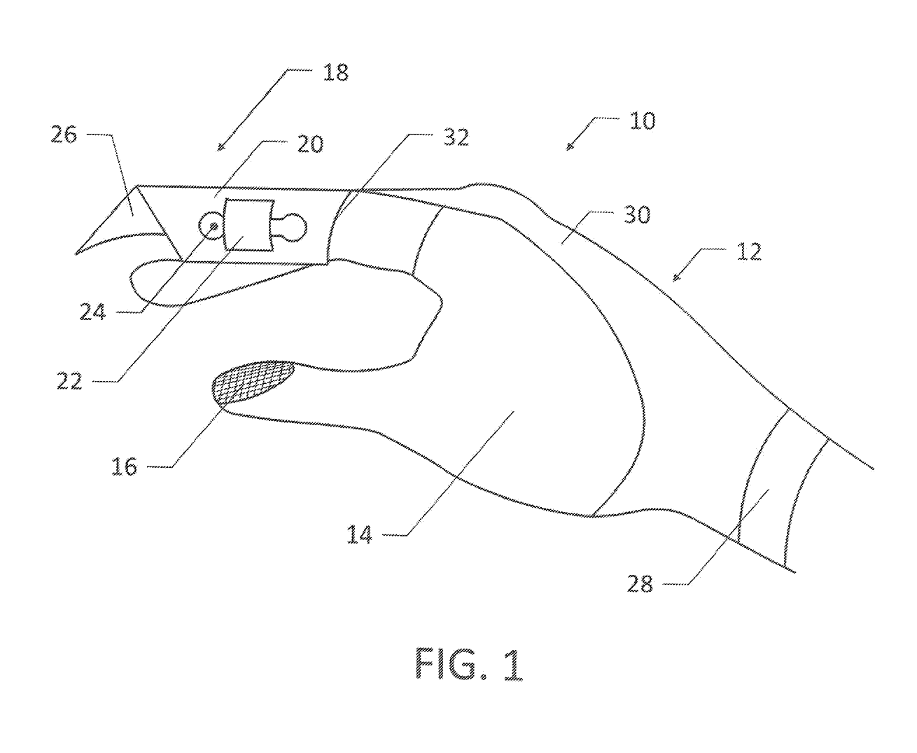

FIG. 1 illustrates the present invention in a first embodiment. The utility knife device 10 consists of sheath 12 connected to blade housing 18. Blade housing 18 includes casing 20 and trigger 22. Casing 22 is attached to sheath 12 at connection point 32. Trigger 22 is movably connected to blade 26 housed within casing 20. Blade housing 18 can be any shape which fits around a user's finger, preferably the user's index finger. Additionally, blade housing 18 can he made of any material which is capable of safely securing a blade inside. Blade housing 18 is connected to sheath 12 by any known method of secure connection at connection point 32. Examples of connection methods between two materials include the use of a heat seal, glue, chemical seal or threading the materials of blade housing 18 and sheath 12 together. Sheath 12 is preferably a glove which covers the user's hand and is held in place by wrist portion 28. Wrist portion 28 can be made of elastic or include a strap for attachment by way of a hook and loop connection, such as Velcro®.

Sheath 12 can be made up of one sturdy material but is preferably comprised of a protective cover 14 and soft cover 30. Protective cover 14 is made of a material which is resistant to puncturing but malleable enough to bend. Soft cover 30 covers the remainder of the hand and can be made of a less versatile material, such as cotton, vinyl or polyester. A tip cover 16 is optionally added to the user's thumb opposite the blade 26. Tip cover 16 is made up of a hardened material which is very difficult or impossible to penetrate with blade 26.

In the present illustration blade 26 is shown extending from casing 20 such that the user can make a cut with blade 26. An optional shield located near or around blade 26 can be added as an additional safety feature. Blade 26 is preferably held into place outside of blade housing 18 when pressure is put on trigger 22 by the user. The current view shows trigger 22 in the middle position of lock track 24. When the user releases trigger 22 it is preferable that the blade 26 springs back into blade housing 18 for safety purposes. This feature requires that the user provide some pressure on trigger 22 to operate blade 26. However, note that in the alternative the blade 26 can be designed to lock into place in its current position in lock track 24, as further defined, such that the user is not required to place pressure on trigger 22 when making a cut.

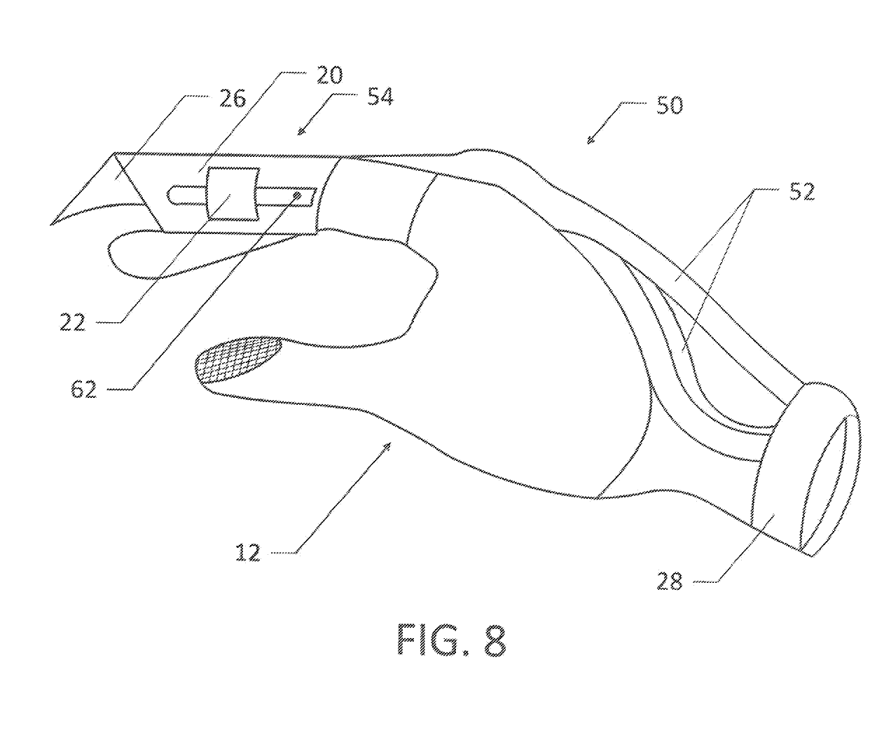

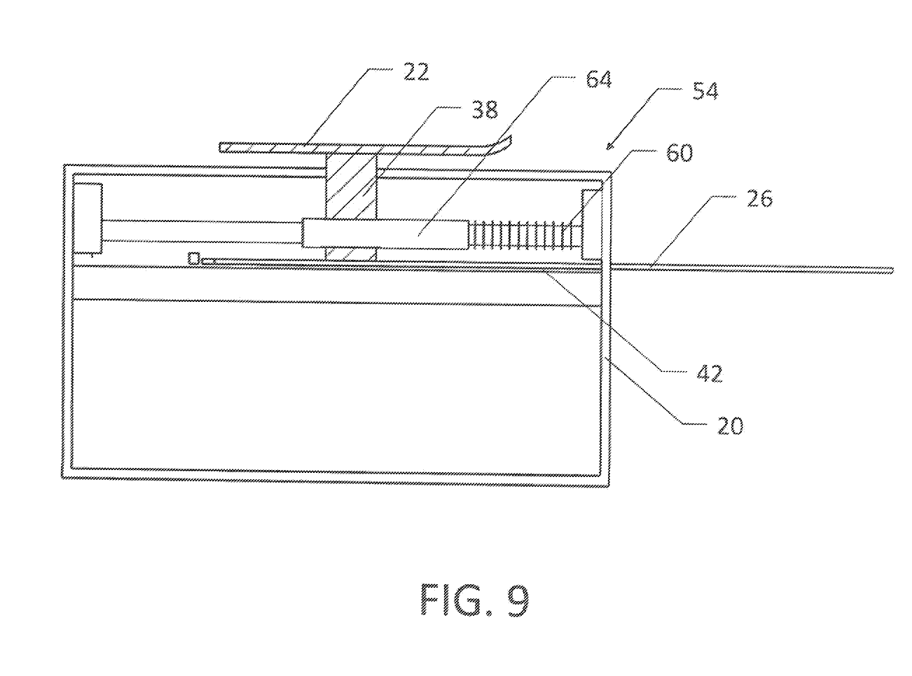

Blade 26 is shown as a razor blade which is curved or hooked downward so that the user can easily extend blade 26 by slightly depressing trigger 22 and moving trigger 22 into position. However, the shape of blade 26 is not limited to the illustrated design. Instead, the blade can be designed in any manner which allows the use to make an appropriate cut. Once held in place or locked in place, blade 26 can be used to make a cut, such as slicing open a cardboard box or cutting a carpet for use. Trigger 22 is purposefully positioned on casing 20 along the side of index finger for the purpose of allowing the user to—with one hand action—extend and use blade 26. After activating trigger 22 blade 26 would either spring back into position within blade housing 18 (as illustrated in FIGS. 8 and 9) or the user would retract blade by placing pressure on trigger 22. In either method of retracting the blade 26, the user can easily reach trigger 22 with his/her thumb tip to manipulate trigger 22 into the appropriate position.

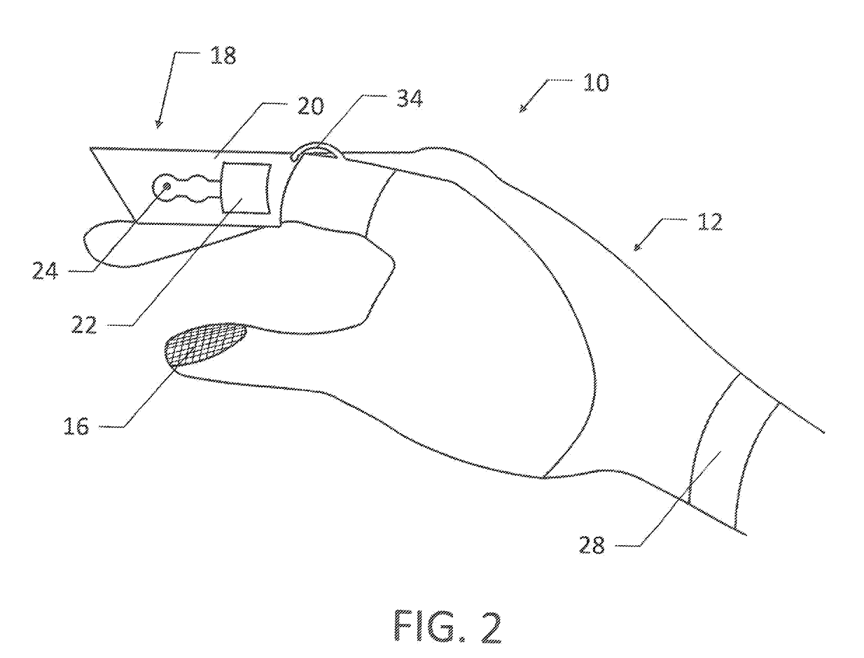

FIG. 2 illustrates the present utility knife 10 with the blade 26 (not shown) fully retracted within blade housing 18. Trigger 22 is shown in the initial position on lock track 24. When the trigger is in this position. the user can easily carry the blade in an accessible but safe manner. The user is still able to work on tasks that do not require the use of the blade. A strap 34 is shown attaching casing 20 to sheath 12. However, the connection between casing 20 and sheath 12 can consist of multiple straps or any other type of attachment or connection method, as discussed above.

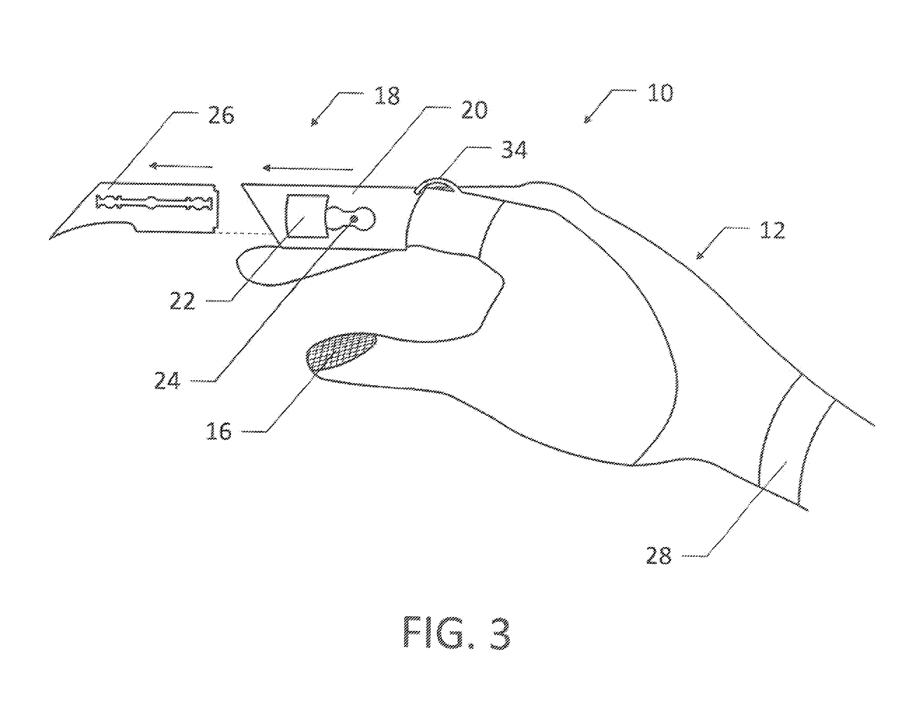

As illustrated in FIG. 3, blade 26 can be ejected from casing 20 to easily change a dull or broken blade. Arrows illustrate the ejection of blade 26 from casing 20. In the preferable method, trigger 22 is pushed to the last position on lock track 24. Trigger 22 lifts slightly upward to release blade 26 when in the illustrated position on lock track 24. Any known method of extracting an old blade from blade housing 18 can be used. As an example, the blade housing 18 could be opened and the blade 26 changed in that manner as well.

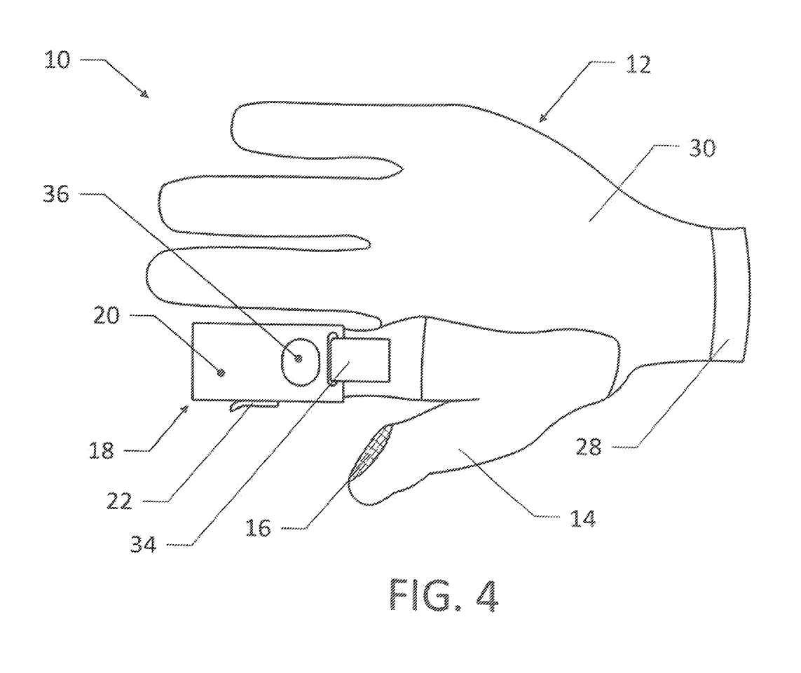

FIG. 4 shows a top view of the present utility knife device 10. The users hand is generally covered by the device 10. Blade housing 18 encloses the index finger of the user. It is desirable that the full index finger is not enclosed by blade housing 18, but instead, the index finger is covered from the tip to the middle joint, thereby allowing the finger to bend. However, the device should not be limited to this functionality. Instead blade housing 18 may cover the entire finger and/or portions of sheath 12. Additionally, although blade housing 18 appears non-malleable, blade housing could be made of a hardened, semi-malleable material to allow some limited movement.

In one embodiment a cut out or grip is provided at the user's knuckle. Knuckle portion 36, as shown, is simply an opening in casing 20 which allows additional room to bend the index finger. The opening can be optionally covered with fabric. However, knuckle portion 36 could also be a grip, made of material which provides frictional engagement with the user's knuckle, located on the inside of the casing 20. The optional grip would allow additional stability to grip and hold the blade steady while making a cut.

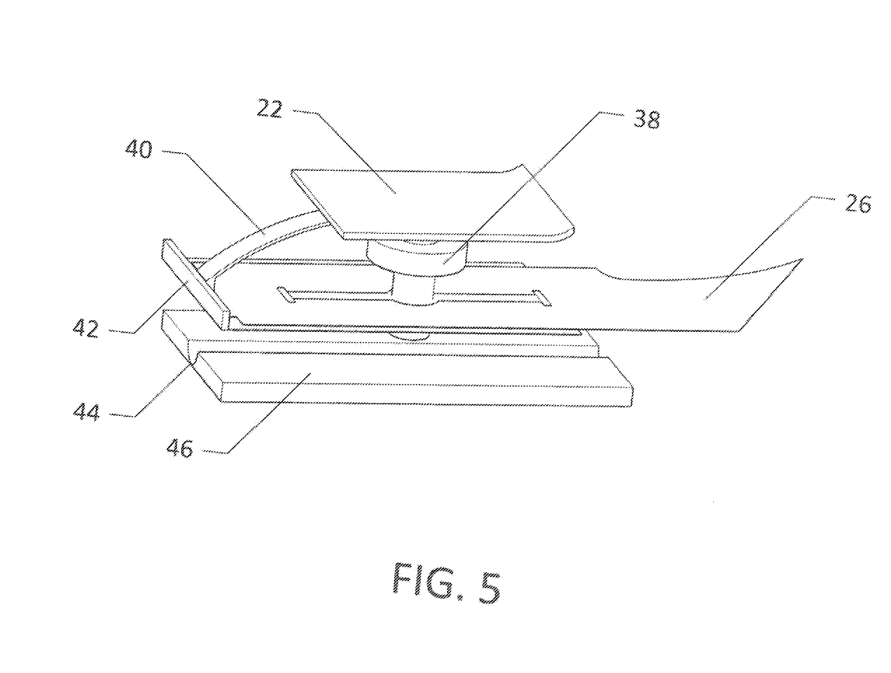

One method of extending and retracting blade 26 is illustrated in FIGS. 5-7. However, any known method of providing an extendable and retractable blade can be used in the present invention. The invention should not be limited to the example shown.

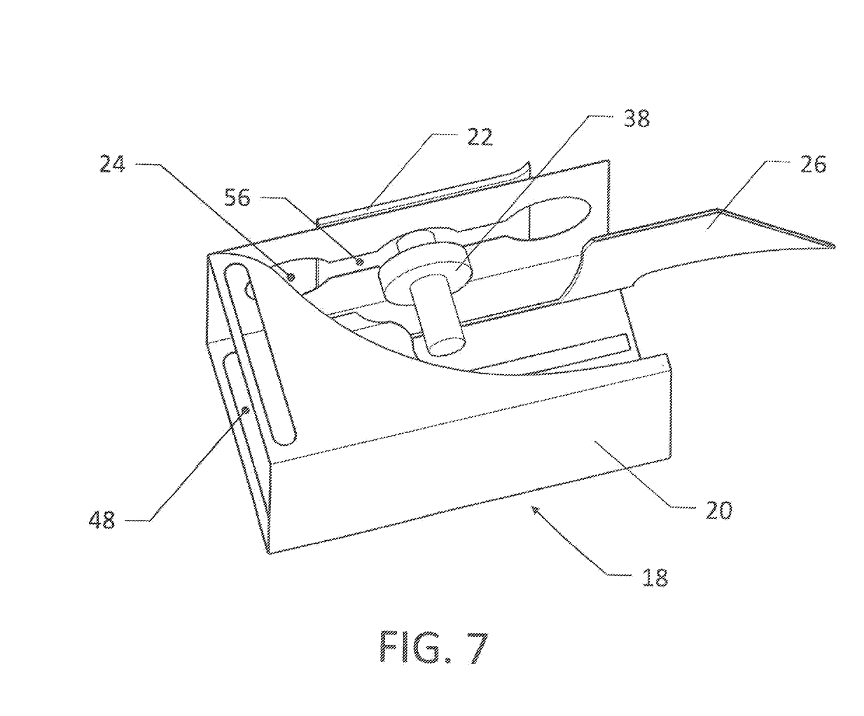

An expanded parts view of functional component parts of the blade housing is shown in FIG. 5. Casing (not shown) is removed from the illustration for purposes of clarity. Trigger 22 attaches to a lock pole 38 which has a portion with a small diameter and a portion with a larger diameter. Turning to FIG. 7, a perspective view with casing 20 and blade 26 cut away is shown. The action between trigger 22, lock pole 38 and lock track 24 is illustrated, When trigger 22 is depressed the portion of lock pole 38 with the small diameter is capable of sliding through lock track 24, through channels 56, to reach any position. Channels 56 are designed to correspond with the smaller diameter size of lock pole 38. Upon release of trigger 22, lock pole 38 pops back up into place such that the portion of lock pole 38 with the larger diameter fits into the corresponding desired position of lock track 24. Thus, the lock pole 38 is locked in place (since the portion of lock pole 38 with the larger diameter is incapable of fitting through the narrow channels 56 on lock track 24).

Returning to FIG. 5, pole spring 40 provides resistance for trigger 22 and lock pole 38. The pole spring 40 allows for the depression of lock pole 38 enough for the portion of lock pole 38 with the larger diameter to fit under casing 20 and thereby under the narrow channels 56 along lock track 24 (as illustrated in FIG. 7). For illustration purposes, pole spring 40 is shown larger than would be necessary in order to achieve the spring-like effect. Additionally, pole spring could be attached to the lock pole 38 underneath the casing 20 so as not to interfere with lock track 24.

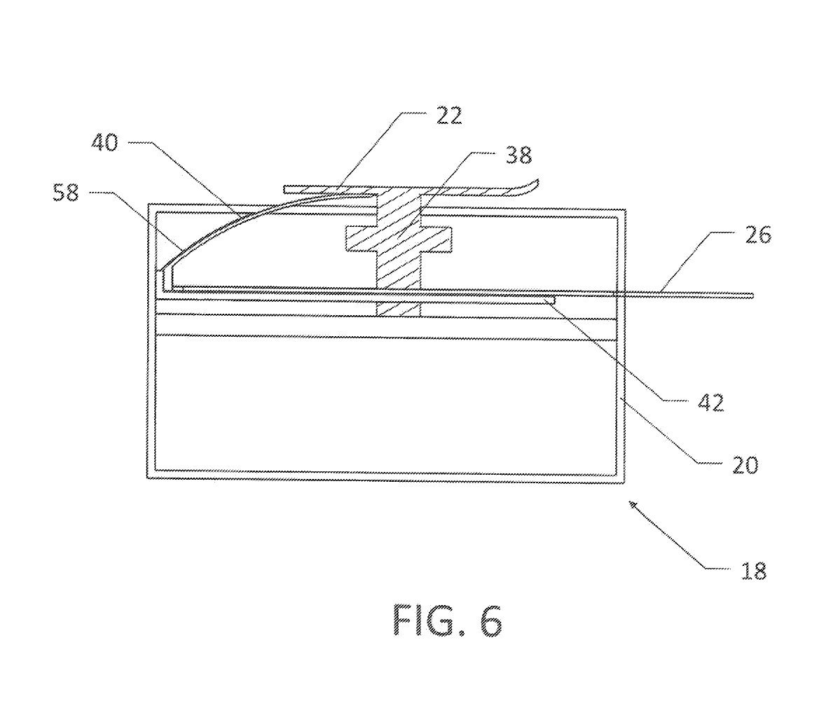

FIG. 6 is a cross section view of blade housing 18. A positioning slope 58 within casing 20 provides a guide for pole spring 40 which connects trigger 22 and lock pole 38 to blade tray 42. Lock pole 38 engages blade 26, which sits securely in blade tray 42. When trigger 22 is depressed and slid by user, lock pole 38 causes blade 26 and blade tray 42 to shift as well.

In FIG. 7, strap opening 48 is also shown, as a method of attaching casing 20 to sheath 12 (not shown). Note, FIG. 7 is for illustrative purposes to show lock pole 38 and lock track 24 and therefore does not illustrate blade tray, pole spring and several other features of the present method of retracting blade 26.

An alternate embodiment 50 of the present invention is shown in FIG. 8. In the alternate embodiment 50, sheath 12 only covers the user's index finger and thumb. A series of straps 52 connects sheath 12 to wrist portion 28. Thus, the user's other three fingers are left free and exposed. Additionally, an alternate blade housing 54 is illustrated. The alternate blade housing 54 can also operate by a press and slide motion of a trigger 22 along a slide channel 62 located on casing 20. However, as illustrated slide channel 62 is one long thin channel. As further illustrated in FIG. 9 alternate blade housing 54 has a spring 60 housed within casing 20. Lock pole 38, attached to trigger 22, engages spring post 64, blade 26 and blade tray 42. When user engages trigger 22 and slides lock pole 38 along slide channel 62 to expose blade 26, spring post 64 and spring 60 are thrust forward, compressing spring 60. Blade 26 and blade tray 42 move in conjunction with spring post 64, exposing blade 26 outside of casing 20. A partial frictional engagement can be provided such that when the blade 26 is in the fully exposed position, the blade 26 is partially held into place by the frictional engagement (such engagement can be provided in any known manner, such as narrowing of slide channel closer to the front or exit point of blade 26). Upon release of pressure on trigger 22, spring 60 releases tension and pulls blade 26 back within casing 20.

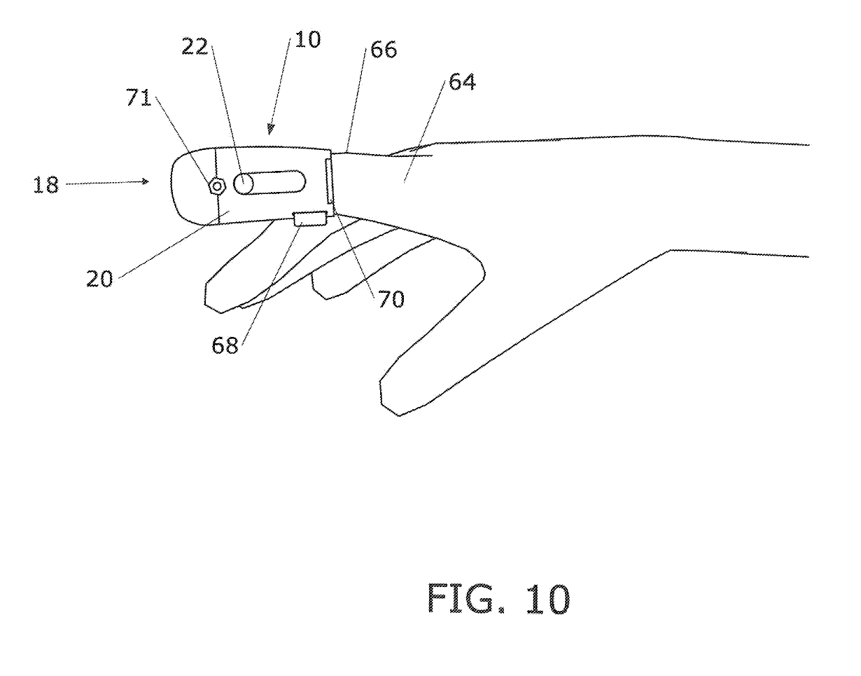

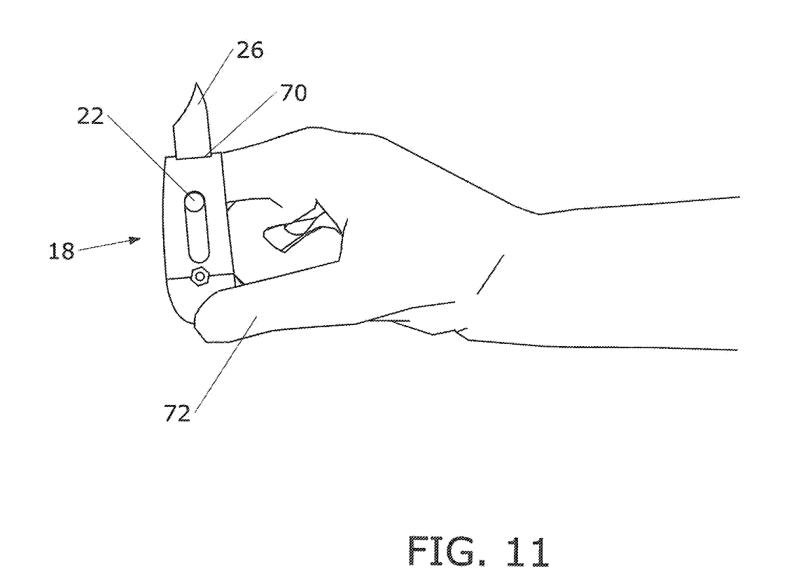

The preferred embodiment of the present invention is illustrated in FIG. 10. Utility knife device 10 slides over user's first digit 64. However, unlike the previously described embodiment, this embodiment fits over the tip of the user's first digit 64, similar to a thimble used for sewing. Utility knife device 10 encompasses user's first digit 64 up to secondary knuckle 66. Utility knife device 10 includes blade housing 18 and strap 68. Blade housing 18, having a forward end and an aft end, covers user's first digit and includes blade 26 (not shown), trigger 22, casing 20, and adjustment knob 71. Blade housing 18 is secured to user's first digit 64 by way of strap 68. Trigger 22 is in the closed position in the current view. By translating trigger 22 toward blade opening 70, the blade of utility knife device 10 exits blade opening 70 at the art end of blade housing 18. The blade 26 (shown in FIG. 11) exits the device 10 in a rearward (“aft”) manner, bark towards the user's hand if the user's first digit 64 is fully extended.

In order to accommodate varying hand and finger size, the alternate embodiment shown in FIG. 10 preferably includes adjustment knob 71. By rotating adjustment knob 71, a user is capable of increasing or decreasing the length of knife device 10. Thus, the present invention provides a universal fit.

FIG. 11 shows the preferred embodiment of the present invention with blade 26 extended. The reader will observe that trigger 22 is now in the open position (closest to blade opening 70). Similar to previously described embodiments, the user can easily slide trigger 22 with second digit 72 in order to extend or retract blade 26. It is also noteworthy that the user is capable of bending his or her first digit 64 at the secondary knuckle 66 (not shown as it is hidden by blade housing 18). This allows for a significant amount of flexibility in the user's first digit despite attachment to the blade housing 18.

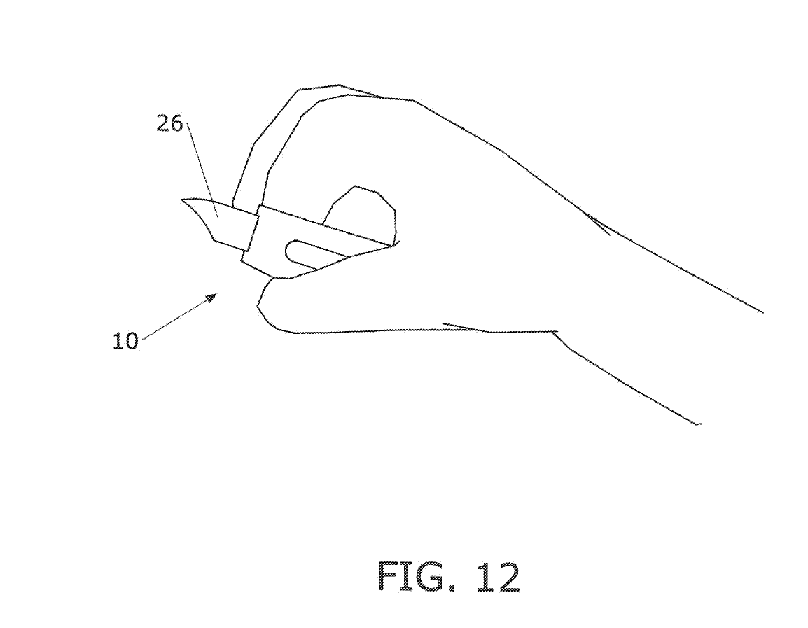

FIG. 12 illustrates an advantage of using the preferred embodiment of the present invention. Once the user creates a fist with his or her hand, utility knife device 10 is directed in such a way that blade 26 is directed away from the user, as shown. The advantage of this configuration is realized by the leverage created when the user's hand is in this position. To those familiar with the art, it is understood that a user has more of a leverage advantage with the configuration shown in FIG. 12 than the previous embodiment described. This is due to the primary components providing the force to cut an object. In the current embodiment, the force is created with the user's wrist and arm, whereas the force in the previous embodiment relies on the strength of the user's first digit.

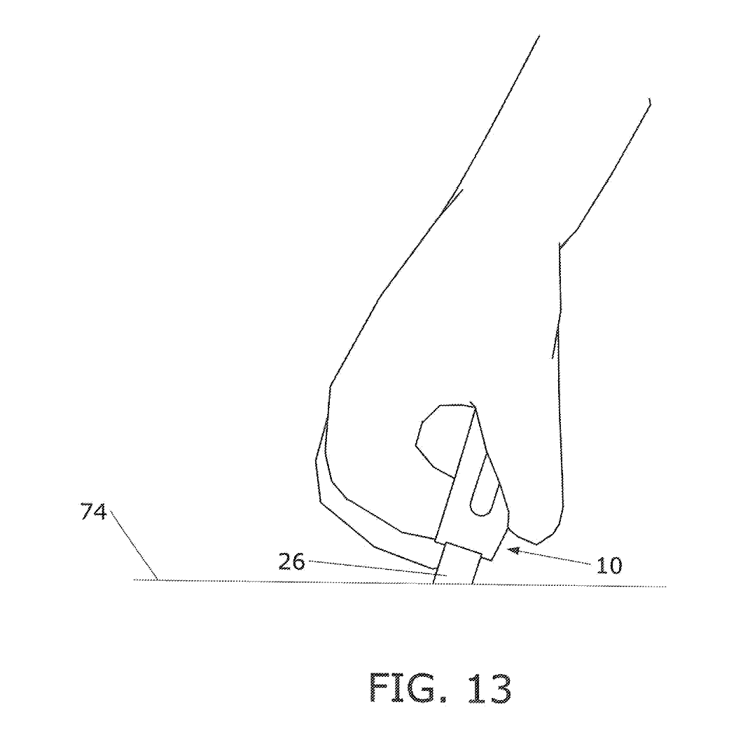

FIG. 13 shows an application of the present invention. Utility knife device 10 is in the “blade open” configuration. Blade 26 is inserted into the object to be cut, such as cardboard box 74. Upon cutting the desired object, the user may move on to the next object or retract blade 26 in order to perform other duties. This is accomplished with the current invention still attached to the user's first digit.

The preceding description contains significant detail regarding the novel aspects of the present invention. it should not be construed, however, as limiting the scope of the invention but rather as providing illustrations of the preferred embodiments of the invention. As an example, the blade housing can provide any known method of providing a trigger which is capable of extending and retracting the blade. Additionally, sheath can consist of a glove-like covering or can merely cover the user's index linger and thumb. Thus, the scope of the invention should be fixed by the following claims, rather than by the examples given.

Having described my invention, claim:

1. A utility knife device for use by a use having a hand with a thumb and a finger, said utility knife device comprising:
a. a blade housing coveting surrounding said finger of said user, said blade housing having;
i. a casing:
ii. a blade contained within said casing;
iii. a trigger connected to said blade; and
b. wherein said blade housing has a forward end and an aft end; and
c. wherein said trigger can be adjusted by said user such that said blade extends out of said casing at said aft end of said blade housing to expose said blade for use.

2. The utility knife device of claim 1, wherein said blade housing further comprises an adjustment knob configured adjust said blade housing.

3. The utility knife device of claim 1, wherein said blade housing is connected to a strap, wherein said strap is configured to secure said blade housing to said finger of said user.

4. The utility knife device of claim 1, wherein said blade has a sharpened hook.

5. The utility knife device of claim 1, wherein said utility knife further comprises:
a. a sheath attached to said blade housing;
b. a protective cover surrounding said thumb and finger of said user; and
c. a soft cover surrounding said hand of said user.

6. The utility knife device of claim 5, wherein said sheath is made up of a malleable but strong material.

7. The utility knife device of claim 6, wherein said sheath further comprises a tip cover located over said tip of said thumb of said user.

8. The utility knife device of claim 1, wherein said aft end of said blade housing extends to a secondary knuckle on said finger of said user.

9. The utility knife device of claim 1, wherein said trigger slides along a lock track opening on said casing.

10. The utility knife device of claim 9, wherein said blade housing further comprises:
a. a series of positions and connecting, channels along said lock track;
b. a blade tray holding said blade;
c. a lock pole attached to said trigger and engaging said blade tray, said locking pole having a portion with a small diameter and a portion with a large diameter;
d. wherein said trigger and said locking pole are capable of being depressed downward into said casing such that said portion of said locking pole with a large diameter is capable of moving under said channels on said lock track; and
e. wherein when said trigger is released said portion of said locking pole with a large diameter pops back up into said series of positions along said lock track which are capable of accepting said portion of said locking pole with a large diameter thereby locking said locking pole and said blade in place.

11. A utility knife device for use by a user in cutting through a piece of matter having a hand with a finger, a secondary knuckle and a thumb, said utility knife device comprising:
a. a blade housing, having a forward end and an at end, surrounding said index finger of said user, wherein said blade housing extends at said at end to said secondary knuckle of said user;
b. wherein said blade housing further comprises:
i. a casing;
ii. a blade contained within said casing;
iii. a trigger connected to said blade; and
iv. a blade opening;
c. wherein said blade opening is located at said aft end of said blade housing such that said trigger can be adjusted by said user such that said blade extends out of said casing through said blade opening to expose said blade for use; and
d. wherein said user can leverage said strength of said hand of said user by bending said finger and applying said blade to said piece of matter with said finger in a bent position.

12. The utility knife device of claim 1, wherein said blade housing further comprises an adjustment knob configured adjust said blade housing.

13. The utility knife device of claim 11, wherein said blade housing is connected to a strap, wherein said strap is configured to secure said blade housing to said finger of said user.

14. The utility knife device of claim 11, wherein said blade has a sharpened hook.

15. The utility knife device of claim 11, wherein said utility knife further comprises:
a. a sheath attached to said blade housing;
b. a protective cover surrounding said thumb and finger of said user; and
c. a soft cover surrounding said hand of said user.

16. The utility knife device of claim 15, wherein said sheath is made up of a malleable but strong material.

17. The utility knife device of claim 16, wherein said sheath further comprises a tip cover located over said tip of said thumb of said user.

18. A utility knife device for use by a user in cutting through a piece of natter having a hand with a finger, a secondary knuckle and a thumb, said utility knife device comprising:
a. a blade housing, having a forward end and an aft end, surrounding said index finger of said user, wherein said blade housing extends at said aft end to said secondary knuckle of said user;
b. wherein said blade housing further comprises:
i. a casing;
ii. a blade contained within said casing;
iii. a trigger connected to said blade; and
iv. a blade opening;
c. wherein said blade opening is located at said aft end of said blade housing such that said trigger can be adjusted by said user applying an amount of force upon said trigger such that said blade extends out of said casing through said blade opening to expose said blade for use and automatically retracts when said amount of force is released from said trigger; and
d. wherein said user can leverage said strength of said hand of said user by bending said finger and applying said blade to said piece of matter with said finger in a bent position.

19. The utility knife device of claim 11, wherein said blade housing further comprises an adjustment knob configured adjust said blade housing.

20. The utility knife device of claim 11, wherein said blade housing is connected to a strap, wherein said strap is configured to secure said blade housing to said finger of said user.
